(19) United States
(12) Patent Application Publication
(10) Pub. No.: US 2025/0367594 A1
(43) Pub. Date: Dec. 4, 2025

(54) Product Purge Bin Mid-Vent As Primary Purge Gas Vent Control

(71) Applicant: ExxonMobil Chemical Patents Inc., Spring, TX (US)

(72) Inventors: Christian X. GEARY, Houston, TX (US); Nathaniel B. GUY, Sewickely, PA (US); Steven P. HAYNIE, Dayton, TX (US); Michael D. LUCAS, Houston, TX (US); Aaron C. MCGINNIS, Houston, TX (US); Matthew E. THOMPSON, Baytown, TX (US)

(21) Appl. No.: 18/852,307

(22) PCT Filed: Mar. 28, 2023
(86) PCT No.: PCT/US2023/065024

§ 371 Date: Sep. 27, 2024

Related U.S. Application Data
(60) Provisional application No. 63/362,577, filed on Apr. 6, 2022.

(51) Int. Cl. B01D 53/22; B01D 45/02; C08F 6/00

(52) U.S. Cl. CPC B01D 53/229; B01D 45/02; B01D 53/226; C08F 6/005; B01D 2257/702

(57) ABSTRACT

Methods for recovering polymer product from gas phase polymerization. A polymer product can be introduced to a purge vessel and contacted with a purge gas to provide a stripped, polymer product. Hydrocarbons such as unreacted monomers can be removed and recycled to polymerization and the purge gas can be recovered and recycled to the purge vessel. Hydrocarbon loss can be eliminated or negligible by using a mid-vent stream from the purge vessel. The mid-vent stream can be selectively flared to control the purge gas concentration within the purge vessel.

### CROSS-REFERENCE TO RELATED APPLICATIONS

This application claims the benefit of U.S. Provisional Application 63/362,577, filed on Apr. 6, 2022 entitled “Product Purge Bin Mid-Vent As Primary Purge Gas Vent Control”, the entirety of which is incorporated by reference herein.

### FIELD

This application relates to olefin polymerization processes. In particular, this disclosure relates to methods for venting gas phase olefin polymerization systems.

### BACKGROUND

Gas phase catalytic polymerization is the predominant technology used to produce polyolefin resins. The catalysts used in the process are contained in solid substrate particles from which the polymer chains grow. Gas phase olefin polymerization technology often employs a fluidized bed, where the particles are fluidized by a gas stream also containing the reactants, such as the olefin monomer or monomers, and a carrier gas. The carrier gas is normally an inert gas such as nitrogen. Processes of this type are described in, for example, EP0475603A1; EP0089691A2; and EP0571826A3.

Pressure control is a vital factor in any gas phase olefin polymerization system and is dominated by the need to remove nitrogen (or other inert carrier gas). Adequate control of the nitrogen is needed to control total reactor pressure or monomer (ethylene) partial pressure. Nitrogen partial pressure is usually controlled to maintain steady reactor conditions by either adding or removing nitrogen. This can be achieved by directly venting nitrogen from the reactor to flare. Doing this without separation facilities to recover the hydrocarbons entrained in the vent gas, however, is not economically attractive and poses potential environmental problems.

In gas-phase polymerization processes, the polymer particles produced in the fluidized bed are typically discharged continuously or discontinuously from the reactor and conveyed pneumatically to a product recovery system. The polymer particles inevitably contain small amounts of unreacted monomer as well as other hydrocarbons added to, or produced in, the polymerization process. A product recovery system, which typically includes a degassing or purging vessel, is typically used to separate and remove unreacted monomers and heavier hydrocarbons from the polymer particles by countercurrent contact with an inert gas, such as nitrogen. The resulting inert gas stream, diluted with unreacted monomer and heavier hydrocarbons is typically recovered from the purge vessel and, after separation of the hydrocarbon components, is recycled as the conveyor gas or as part of the purge stream. Part of the effluent from the purge vessel is removed from the system and currently, since the concentration of unreacted monomer in this stream is too low to render its recovery economically feasible, the vent stream is flared or used as fuel. This not only represents a significant loss of valuable monomer, but also results in regulated environmental emissions.

There is still a need for an improved degassing system for gas phase olefin polymerization processes in which the loss of unreacted monomers in the product vent stream is reduced or eliminated.

### SUMMARY

Method for recovering polymer product from gas phase polymerization are provided. In at least one embodiment, a polymer product including polymer particles, one or more unreacted monomers, one or more other hydrocarbons and conveyor gas can be introduced to a purge vessel and contacted with a purge gas to strip away any unreacted and/or entrained monomers and other hydrocarbons. An overhead stream comprising at least a portion of the unreacted monomers, one or more other hydrocarbons and purge gas and a bottoms stream comprising the polymer particles can be withdrawn from the purge vessel. The overhead stream can be separated into a hydrocarbon stream comprising at least 80 wt % of the hydrocarbons in the overhead stream and a gaseous effluent stream comprising less than 20 wt % of the hydrocarbons. The gaseous effluent stream can be separated, within a first membrane separator, into a first permeate stream that is richer in hydrocarbons and a first residue stream that is leaner in hydrocarbons. The first residue stream can then be separated within a second membrane separator, into a second permeate stream that is richer in hydrocarbons and a second residue stream that is leaner in hydrocarbons. The second permeate stream can be recycled to the purge vessel and the second residue stream can be selectively flared or recycled to the overhead stream prior to separating the overhead stream into the hydrocarbon stream comprising at least 80 wt % of the hydrocarbons in the overhead stream and the gaseous effluent stream comprising less than 20 wt % of the hydrocarbons.

In one or more embodiments, a mid-vent stream comprising at least 70 wt % purge gas can be withdrawn from the purge vessel and selectively flared to control the purge gas concentration within the purge vessel. In one or more other embodiments, the second permeate stream can be selectively flared to control the purge gas concentration within the purge vessel.

### BRIEF DESCRIPTION OF THE DRAWINGS

FIG. 1 depicts a simplified flow diagram for recovering polymer product from gas phase polymerization, according to one or more embodiments described herein.

FIG. 2 depicts the degassing system of FIG. 1 when nitrogen/purge gas removal is performed by flaring from the membrane effluent, according to one or more embodiments described herein.

FIG. 3 depicts the degassing system of FIG. 2 when nitrogen/purge gas removal is performed by flaring from a mid-vent stream, according to one or more embodiments described herein.

### DETAILED DESCRIPTION OF THE EMBODIMENTS

The present disclosure is directed to a degassing method and system for separating and recovering unreacted monomers, other hydrocarbons and purge gas from a solid polymer product. The solid polymer product can be or can include a plurality of polymer particles and/or particulates. The solid polymer product can result from any olefin polymerization process. Suitable olefin polymerization processes can be or can include: (1) gas-phase polymerization processes, including fluidized bed, horizontal stirred bed and vertical stirred bed reactors, (2) bulk processes, including liquid pool and loop reactors, and (3) slurry processes, including continuous stirred-tank, batch stirred-tank, loop and boiling butane reactors. The present disclosure, however, is particularly useful for the recovery of unreacted monomers, other hydrocarbons and purge gas from gas phase polymerization processes. Illustrative monomers include ethylene, propylene, and mixtures of ethylene and/or propylene with or without one or more C4-C8 alpha-olefins.

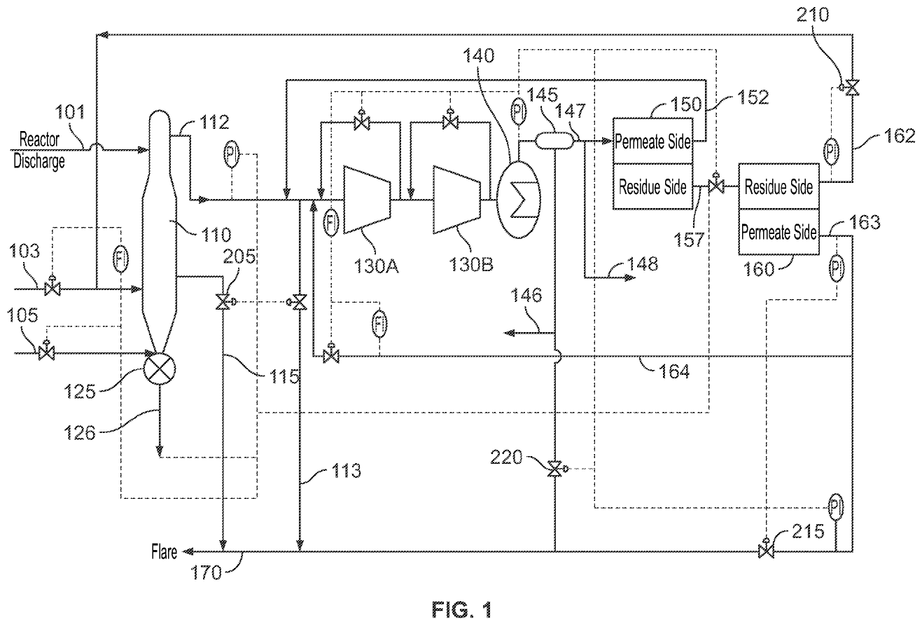

FIG. 1 depicts a simplified flow diagram for recovering polymer product from gas phase polymerization, according to one or more embodiments. The polymer product recovery system can include one or more product purge bins or vessels 110, compressors 130, coolers 140, and separators 145, 150, 160 to strip or otherwise purge entrained gases from a polymer product. A polymer product that has been discharged from a polymerization reactor (stream 101) can be entrained with various amounts of unreacted monomer, assist gas or carrier gas, and one or more other hydrocarbons, such as one or more C4 to C6 alkanes that have been added to the polymerization reaction for gas phase polymerization. As used herein, the term “hydrocarbons” collectively refers to the unreacted monomer(s) and the one or more other hydrocarbon(s) that were added to the polymerization reaction unless specifically stated otherwise.

To help remove the entrained gas(es) from the polymer product, a supply of fresh purge gas, which can be an inert gas such as nitrogen, can be added to a product purge vessel 110 via stream 103, and/or directly to the bottom cone of the purge vessel 110 via stream 105 to strip or otherwise purge the entrained gases from the polymer product. The fresh nitrogen feed to the purge vessel can be less than 5 wt % of the recycled purge gas flow, preferably less than 4 wt %, 3 wt %, 2 wt %, or 1 wt %. The operating conditions in the degassing vessel are not closely controlled, but typically include a temperature from 20° C. to 120° C., such as from 65° C. to 85° C. and a pressure from 100 kPa-a to 200 kPa-a, such as from 130 kPa-a to 165 kPa-a. As the polymer product flows downwardly through the purge vessel 110, the unreacted monomer and other entrained hydrocarbons are stripped or desorbed from the polymer particles and exit the purge vessel 110 with the purge gas via an overhead effluent stream 112. The overhead effluent stream 112 can contain at least 30 mol % nitrogen and at least 40 mol % hydrocarbons. The nitrogen content can also range from about 30 mol % to 50 mol %, or about 35 mol % to 55 mol %, or about 30 mol % to 40 mol %. The total hydrocarbon content (i.e. all the hydrocarbons including unreacted monomers and other alkenes/alkanes) in the overhead effluent stream 112 can range from about 40 mol % to 69 mol %, about 50 mol % to 69 mol %, or about 55 mol % to 69 mol %. The stripped polymer particles fall and collect at the lower end of the purge vessel 110, where it can be removed via a discharge valve 125 as stream 126 for further processing. The gas content in stream 126 is mostly nitrogen, if not all nitrogen gas.

The purge vessel 110 can further include one or more mid-vent streams 115. The one or more-mid vent streams 115 can be located anywhere along the height of the purge vessel 110. In certain embodiments, a single mid-vent stream 115 can be located toward the lower end of the purge vessel 110, but above the fresh nitrogen feed stream 103 and above the bottom cone feed streams 105. The mid-vent stream will typically contain at least 95 wt % inert gas and can contain at least 96 wt %, 97 wt %, 97 wt % or 99 wt % inert gas. In some embodiments, the mid-vent stream consists essentially of inert gas. As will be explained in more detail below, the mid-vent stream 115 can be used to better control the amount of purge gas (i.e. nitrogen) that is added to the purge vessel 110 and flared from the system. It has been surprisingly and unexpectedly discovered that controlling the flow of gas through the mid-vent stream 115 can substantially reduce the amount of hydrocarbon loss, which amounts to significant cost savings. When used, the mid-vent stream 115 contains mostly nitrogen, if not all nitrogen. Very small or trace amounts of unreacted monomers or hydrocarbon could possibly be found in the mid-vent stream 115.

The overhead effluent stream 112 can be sent to a compressor 130 (show in FIG. 1 as a 2-stage compressor comprising 1^{st} stage 130A and second stage 130B) then through a cooler 140 to condense at least part of the lighter hydrocarbons in the effluent stream 112. The compressor 130 can have any number of stages, depending on the amount of flow and/or pressure requirements; as noted, a 2-stage compressor is illustrated in FIG. 1. The condensed hydrocarbons from the cooler 140 can be separated within one or more separators or accumulators 145 and recovered via stream 146. Any recovered hydrocarbons can be recycled to the polymerization reactor. The hydrocarbon-containing stream 146 can contain at least 80 wt %, at least 85 wt %, at least 90 wt %, at least 92 wt %, at least 94 wt %, or at least 96 wt % of the hydrocarbons (including unreacted monomers and other alkenes/alkanes) that were in the overhead stream 112. The pressurized and cooled gas can exit the separator(s) 145 via stream 147. This gaseous effluent stream 147 can contain less than 20 wt % of the hydrocarbons that were in the overhead stream 112, such as less than 15 wt %, 12 wt %, 10 wt %, 9 wt %, 8 wt %, 6 wt %, or 5 wt %. Stream 147 can then be fed to one or more separation units 150, 160 to further separate the hydrocarbons from the nitrogen. In certain embodiments, all or any portion of the gas stream 147 can be recycled to the polymerization reactor via stream 148 to be used as conveyor gas and/or the gas stream 147 can be sent to the flare (via stream 170) and disposed. Conveyor gas is preferably an inert gas (e.g., nitrogen). In one or more embodiments, the overhead effluent stream 112 can bypass the recovery section and go straight to the flare via bypass stream 113.

Any suitable type of nitrogen separator or separation unit can be used to remove the hydrocarbons from nitrogen. For example, one or more membrane type separators can be used. Two membrane separators 150, 160 are shown in FIG. 1. In certain embodiments, a first membrane separator 150 can separate the cooled gas stream 147 exiting the separator 145 into a first fraction 152 that is rich in hydrocarbons and lean in nitrogen compared to the hydrocarbon content of the cooled gas stream 147 entering the first separator 150, and a second fraction 157 that is lean in hydrocarbons and rich in nitrogen compared to the hydrocarbon content of the cooled gas stream 147. The first fraction 152 that is rich in hydrocarbons can be recycled to the front end of the compressor 130. The first fraction 152 can be mostly nitrogen with less than 50 wt % hydrocarbons (preferably 22 wt % or less, 23 wt % or less, 25 wt % or less, 27 wt % or less, 30 wt % or less, 35 wt % or less, or 40 wt % or less). The nitrogen content can also range from a low of about 50 wt %, 55 wt %, or 60 wt % to a high of about 70 wt %, 75 wt %, or 80 wt %. The total hydrocarbon content can range from a low of about 20 wt %, 25 wt or 30 wt % to a high of about 35 wt %, 42 wt % or 49 wt %. The unreacted monomer content in the first fraction 152 can be about 5, 10, or 15 wt % to about 20, 25 or 30 wt %.

The second fraction 157 that is lean in hydrocarbons can be fed to a second membrane separator 160 for further separation and recovery. The second membrane separator 160 can further separate the second fraction 157 that is lean in hydrocarbons compared to the hydrocarbon content of the cooled gas stream 147 into a third fraction (via stream 162) that is lean in hydrocarbons and a fourth fraction (via stream 163) that is rich in hydrocarbons as compared to the hydrocarbon content of the second fraction 157. The third fraction (via stream 162) can be mostly nitrogen with less than about 30 mol % hydrocarbons (preferably less than 10 wt %, less than 8 wt %, less than 7 wt %, less than 6 wt %, less than 5 wt %, less than 4 wt %, less than 3 wt %, or less than 2 wt %) and can be recycled to the purge vessel 110 to use as the purge gas within the purge vessel 110. The fourth fraction (via stream 163) can also be mostly nitrogen with less than about 30 wt % hydrocarbons (preferably less than 20 wt %, less than 18 wt %, less than 17 wt %, less than 16 wt %, less than 15 wt %, less than 14 wt %, less than 13 wt %, or less than 10 wt %). The nitrogen content can also range from a low of about 75, 80, or 90 wt % to a high of about 93, 95 or 99 wt %. The hydrocarbon content (i.e. total hydrocarbons including unreacted monomers and other alkanes) can range from a low of about 0.5 wt %, 1 wt or 5 wt % to a high of about 15 wt %, 18 wt % or 25 wt %. Of which, the unreacted monomer content can be about 70 wt %, 75 wt % or 80 wt % to about 90 wt %, 95 wt % or 100 wt %. All or any portion of this fourth fraction (stream 163) can be sent to the flare via stream 170. In certain embodiments, all or any portion of the fourth fraction (stream 163) can be recycled to the front end of the compressor 130 via stream 164. In certain embodiments, any portion of the fourth fraction (stream 163) can be recycled to the front end of the compressor 130 via stream 164 while any portion any portion of this fourth fraction (stream 163) can be sent to the flare via stream 170.

In operation, a series of control valves can be used to control the gas flow rates throughout the process. In one embodiment, three control valves 205, 210 and 215 can be used to control the purge system to significantly reduce hydrocarbon loss in the system. A first valve 205, for example, can be used to control the gas flow through the mid-vent stream 115 from the purge vessel 110 to the flare via stream 170. A second valve 210 can be used to control the recycled third fraction (via stream 162) exiting the second membrane separator 160 to the purge vessel 110. A third valve 215 can be used to control the gas flow of the fourth fraction (stream 163) exiting the second membrane separator 160 to the flare via stream 170. At a minimum, this three valve control system can regulate the amount of purge gas needed to effectively remove entrained gases from the polymer product while minimizing hydrocarbon losses via the flare. By “minimizing”, it is meant that the flare stream contains less than 3 wt %, less than 2 wt %, less than 1 wt %, less than 0.5 wt %, less than 100 ppmw, less than 10 ppmw, or less than 1 ppmw hydrocarbon(s). In some embodiment, the flare stream will contain zero hydrocarbons.

Upon startup of the system, the polymer product having one or more entrained gases can be introduced to the purge vessel 110 via the feed stream 101. The polymer product can be contacted with a countercurrent flow of fresh purge gas, such as nitrogen, delivered to the vessel 110 through stream 103. The same or different purge gas can be added via stream 105 to the bottom portion or bottom cone of the purge vessel 110 to help prevent the polymer particles from sticking and/or plugging the bottom of the vessel 110. This stream 105 can be continuous or intermittent but is usually a continuous flow. The stripped polymer particles can be removed from the purge vessel 110 using the rotary valve 125 or something similar and carried away via stream 126.

The overhead stream 112 from the purge vessel 110 containing unreacted monomers, conveyor gas and purge gas (again, noting that conveyor and/or purge gas are preferably inert gases, such as nitrogen) can be removed from the vessel 110 and compressed, cooled and eventually separated into the recycle stream 162 to the purge vessel 110 and the fourth fraction (stream 163) exiting the second separator 160 sent to the flare. Some of this fourth fraction/disposal stream 163 can be recycled to the front end of the compressors 130 via recycle stream 164. This flow configuration can continue until the pressure in the recovery system chiller 140 is high enough that control valve 220 begins to open to remove gas to the flare. This means the system is “full” and needs to start removing molecules. Once the system capacity has been met, the valve 205 on the mid vent stream 115 can start to open and allow gas to flow through the mid vent stream 115 to the flare. While this mid-vent valve 205 is opening, the control valve 215 on the fourth fraction (stream 163) exiting the second separator 160 can begin to close. When the mid vent gas flow through stream 115 exceeds the fresh purge gas flow to the purge vessel 110 (stream 105), the fresh purge gas stream 103 can be stopped. The system is now at steady state or substantially at steady state. Flow through the mid vent valve 205 can then be used to control the removal of purge gas from the system, and significantly reduce hydrocarbon losses.

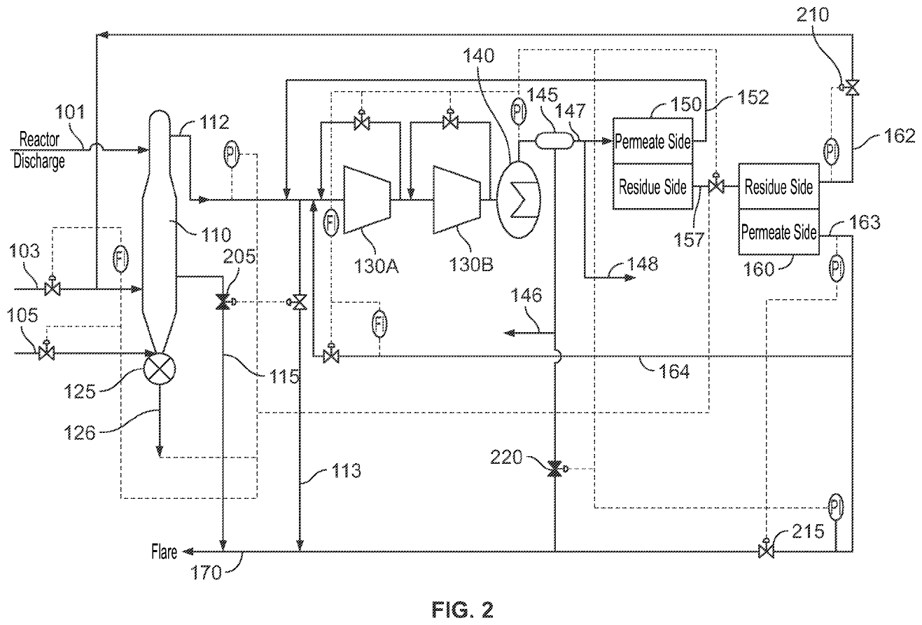

FIG. 2 illustrates one mode for removing inerts (i.e. nitrogen) and controlling the purge vent by flaring the second membrane stream effluent (i.e. the fourth fraction) stream 163. In this embodiment, inert removal and purge control can be performed through the second membrane stream effluent (i.e. the fourth fraction) stream 163 sent to flare. To accomplish this mode for removal, the membrane effluent valve 215 can be opened and the mid-vent control valve 205 can be closed, as depicted in FIG. 2. Table 1 below summarizes the simulated flow rates and stream compositions for this scenario.

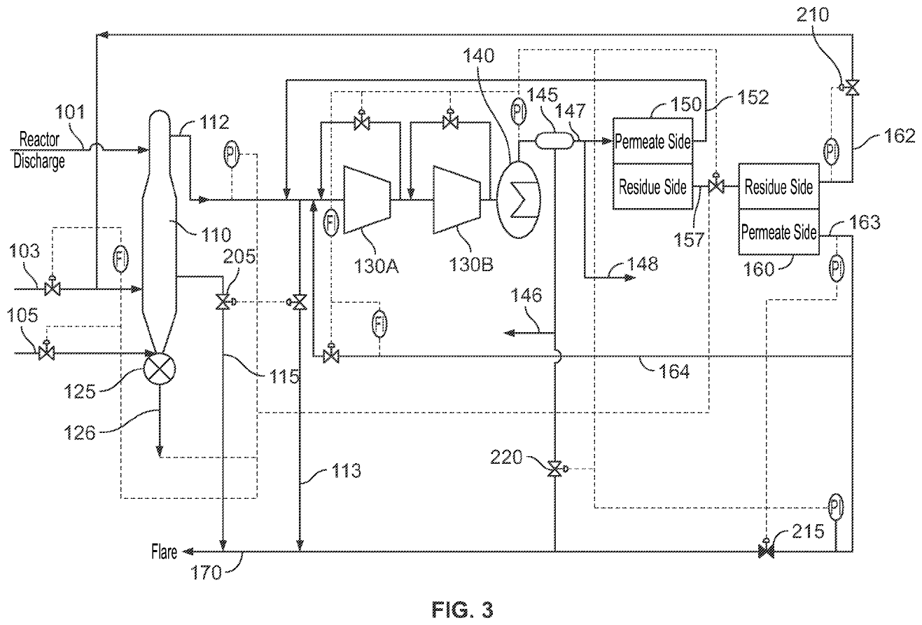

FIG. 3 illustrates another mode for removing inerts (i.e. nitrogen) and controlling the purge vent by flaring the mid-vent stream 115 from the purge vessel 110. In this embodiment, the mid-vent control valve 205 can be opened and the membrane effluent valve 215 can be closed. Table 2 summarizes the simulated flow rates and stream compositions for this event.

TABLE 1
Stream flowrates and compositions for nitrogen removal
through second membrane effluent 163 to flare.

| Stream | Flow Rate | N2 | C2═ | Other HC |
|---|---|---|---|---|
| No. | (T/hr) | (mol %) | (mol %) | (mol %) |
| 103 | 0 | — | — | — |
| 105 | 0.5 | 100 | — | — |
| 112 | 11.2 | 40 | 9 | 51 |
| 115 | 0 | — | — | — |
| 126 | 0.1 | 100 | — | — |
| 146 | 8.4 | 2 | 9 | 89 |
| 148 | 0.3 | 75 | 22 | 3 |
| 152 | 4.2 | 63 | 32 | 5 |
| 162 | 2.0 | 95 | 5 | 0 |
| 164 | 0.9 | 82 | 16 | 2 |
| 170 | 0.5 | 82 | 16 | 2 |

TABLE 2
Stream flowrates and compositions
for mid-vent stream 115 to flare.

| Stream | Flow Rate | N2 | C2═ | Other HC |
|---|---|---|---|---|
| No. | (T/hr) | (mol %) | (mol %) | (mol %) |
| 103 | 0 | — | — | — |
| 105 | 0.5 | 100 | — | — |
| 112 | 10.8 | 37 | 9 | 54 |
| 115 | 0.4 | 97 | 3 | 0 |
| 126 | 0.1 | 100 | — | — |
| 146 | 8.5 | 2 | 12 | 96 |
| 148 | 0.3 | 72 | 25 | 3 |
| 152 | 4.6 | 59 | 35 | 6 |
| 162 | 2.0 | 94 | 6 | 0 |
| 164 | 1.4 | 80 | 18 | 2 |
| 170 | 0 | — | — | — |

Referring to Tables 1 and 2, when the second membrane stream effluent (i.e. the fourth fraction) stream 163 and control valve 215 are used to control the purge vent, the amount of ethylene that is lost to the flare is about 0.08 T/hr (about 160 lb/hr) and the total hydrocarbon loss is 0.09 T/hr (about 180 lb/hr) via stream 170. Conversely, when the mid-vent stream 115 (and control valve 205), as depicted in FIG. 3, are used to control the purge vent, the amount of hydrocarbon loss is significantly less. More particularly, the only hydrocarbon loss is ethylene (0.012 T/hr or about 24 lb/hr) though stream 115, as reported in Table 2

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for recovering polymer product from gas phase polymerization, comprising:
introducing a polymer product to a purge vessel, the polymer product comprising polymer particles, one or more unreacted monomers, one or more other hydrocarbons and conveyor gas;
contacting the polymer product within the purge vessel with a purge gas;
withdrawing an overhead stream from the purge vessel, the overhead stream comprising at least a portion of the unreacted monomers, one or more other hydrocarbons, conveyor gas and purge gas;
withdrawing a bottoms stream from the purge vessel, the bottoms stream comprising the polymer particles;
separating the overhead stream into a hydrocarbon stream comprising at least 80 wt % of the hydrocarbons in the overhead stream and a gaseous effluent stream comprising less than 20 wt % of the hydrocarbons;
separating, within a first membrane separator, the gaseous effluent stream into a first permeate stream that is richer in hydrocarbons and a first residue stream that is leaner in hydrocarbons;
separating, within a second membrane separator, the first residue stream into a second permeate stream that is richer in hydrocarbons and a second residue stream that is leaner in hydrocarbons;
recycling the second residue stream to the purge vessel;
recycling the second permeate stream to the overhead stream prior to separating the overhead stream into the hydrocarbon stream comprising at least 80 wt % of the hydrocarbons in the overhead stream and the gaseous effluent stream comprising less than 20 wt % of the unreacted monomers;
withdrawing a mid-vent stream from the purge vessel, the mid-vent stream comprising at least 70 wt % purge gas; and
selectively flaring the mid-vent stream to control the purge gas concentration within the purge vessel.

2. The method of claim 1, further comprising recycling the first permeate stream that is richer in hydrocarbons to the overhead stream prior to separating the overhead stream into the hydrocarbon stream comprising at least 80 wt % of the hydrocarbons in the overhead stream and the gaseous effluent stream comprising less than 20 wt % of the hydrocarbons.

3. The method of claim 1, further comprising selectively flaring the second permeate stream to control the purge gas concentration within the purge vessel.

4. The method of claim 1, wherein the second permeate stream that is richer in hydrocarbons is not flared.

5. The method of claim 1, wherein the second residue stream is rich in purge gas.

6. The method of claim 1, further comprising introducing a fresh purge gas feed to the purge vessel.

7. The method of claim 6, wherein the fresh purge gas feed to the purge vessel is less than 5 wt % of the recycled purge gas flow.

8. The method of claim 1, wherein the conveyor gas is the same as the purge gas.

9. The method of claim 1, wherein the conveyor gas and the purge gas are both nitrogen.

10. The method of claim 1, wherein the polymer product further comprises one or more saturated hydrocarbons.

11. The method of claim 1, wherein the mid-vent stream comprises at least 95 wt % inert gas.

12. The method of claim 1, wherein the second residue stream that is recycled to the purge vessel is used as the purge gas within the purge vessel.

13. The method of claim 1, wherein the second residue stream that is recycled to the purge vessel is used as a portion of the purge gas added to the purge vessel.

14. A method for recovering polymer product from gas phase polymerization, comprising:
introducing a polymer product to a purge vessel, the polymer product comprising polymer particles, one or more unreacted monomers and conveyor gas;
contacting the polymer product within the purge vessel with a fresh purge gas;
withdrawing an overhead stream from the purge vessel, the overhead stream comprising the unreacted monomers and purge gas;
withdrawing a bottoms stream from the purge vessel, the bottoms stream comprising the polymer particles;
separating the overhead stream into a hydrocarbon stream comprising at least 80 wt % of the hydrocarbons in the overhead stream and a gaseous effluent stream comprising less than 20 wt % of the hydrocarbons;
separating, within a first membrane separator, the gaseous effluent stream into a first permeate stream that is richer in hydrocarbons and a first residue stream that is leaner in hydrocarbons;
separating, within a second membrane separator, the first residue stream into a second permeate stream that is richer in hydrocarbons and a second residue stream that is leaner in hydrocarbons; and
selectively flaring the second permeate stream to control the purge gas concentration within the purge vessel.

15. The method of claim 14, further comprising withdrawing a mid-vent stream from the purge vessel, the mid-vent stream comprising at least 70 wt % inert gas and selectively flaring the mid-vent stream to further control the inert gas concentration within the purge vessel.

16. The method of claim 15, further comprising restricting the fresh purge gas flow to the purge vessel after the mid-vent stream flow exceeds the fresh purge gas flow to the purge vessel.

17. The method of claim 15, further comprising restricting the second permeate stream flow to the flare and recycling the second residue stream to the purge vessel.

18. The method of claim 17, wherein the recycled second residue stream to the purge vessel is used as a portion of the purge gas within the purge vessel.

19. The method of claim 15, further comprising restricting the fresh purge gas flow to the purge vessel after the mid-vent stream flow exceeds the fresh purge gas flow to the purge vessel.

20. The method of claim 19, wherein the recycled second residue stream to the purge vessel is used as the purge gas within the purge vessel.
